(19) United States
(12) Patent Application Publication
(10) Pub. No.: US 2015/0054425 A1
(43) Pub. Date: Feb. 26, 2015

(54) NANOCOMPOSITE COMPOSITIONS AND METHODS OF MAKING

(71) Applicant: Cree, Inc., Durham, NC (US)

(72) Inventors: Peter Guschl, Carpinteria, CA (US); Nalini Gupta, Santa Barbara, CA (US)

(21) Appl. No.: 14/447,357

(22) Filed: Jul. 30, 2014

Related U.S. Application Data
(60) Provisional application No. 61/868,283, filed on Aug. 21, 2013.

(51) Int. Cl. C08G 77/38; H05B 33/08; C09D 183/04

(52) U.S. Cl. CPC C08G 77/38; C09D 183/04; H05B 33/08
USPC 315/294; 525/474; 524/588

(57) ABSTRACT

The present disclosure relates to coupling agents capable of dispersing a high loading of nanoparticles into a polymer matrix to provide a nanocomposite with a combination of desirable optical and mechanical properties of the constituent materials. More particularly, the present disclosure relates to high loading nanocomposites comprising nanoparticles coupled with a polymer matrix. Light-emitting devices incorporating the nanocomposite are also disclosed.

### CROSS-REFERENCE TO RELATED APPLICATIONS

This application claims the benefit of U.S. Provisional Application No. 61/868,283, filed Aug. 21, 2013, the entire contents of which is hereby incorporated by reference.

### TECHNICAL FIELD

The present disclosure relates to polymer nanocomposites comprising a high loading of nanoparticles, coupling agents capable of dispersing the high loading of nanoparticles into a polymer matrix to provide the nanocomposite, and nanocomposites therefrom with a combination of desirable optical and mechanical properties. More particularly, the present disclosure relates to high refractive index nanocomposites of a polymer matrix comprising coupled nanoparticles providing efficiency gain in white-light LED devices.

### BACKGROUND

Nanoparticle incorporation into polymer matrices is challenging. Nanoparticles tend to agglomerate with neighboring nanoparticles, especially at high loadings (>10 volume percent (vol %). This agglomeration can limit many material properties, such as reducing optical transparency in lighting devices by causing light scattering. Certain polymers, e.g., such as polysilicones and polysiloxanes, are particularly difficult polymer matrices in which to incorporate a high loading (e.g., >10 vol %) of nanoparticles such that they are efficiently and effectively dispersed.

### SUMMARY

In a first embodiment, a composition is provided comprising one or more nanoparticles associated with one or more coupling agents and a polymer matrix dispersed in the one or more nanoparticles. In one aspect, the one or more nanoparticles are present at more than about 10 volume percent to less than 99 volume percent. In another aspect, alone or in combination with any previous aspects, the nanoparticles are present at about 50 weight percent to less than 99 weight percent. In another aspect, alone or in combination with any previous aspects, the polymer matrix is a polysiloxane polymer, or one or more precursor components, blends, or copolymers thereof. In another aspect, alone or in combination with any previous aspects, the one or more coupling agents comprise one or more chemical functional groups and/or one or more ligands providing compatibility with the polymer matrix. In another aspect, alone or in combination with any previous aspects, the polymer matrix comprises one or more functional groups capable of reacting with the one or more chemical functional groups of the one or more coupling agents. In another aspect, alone or in combination with any previous aspects, the one or more nanoparticles are coupled to the one or more coupling agents and/or the polymer matrix. In another aspect, alone or in combination with any previous aspects, the composition is a curable coating, film, layer, or shape. In another aspect, alone or in combination with any previous aspects, the nanoparticles are of an average refractive index of between 1.7 and 2.9. In another aspect, alone or in combination with any previous aspects, the one or more nanoparticles are diamond, silicon carbide, calcium titanate, oxides of one or more of zirconium, hafnium, yttrium, titanium, tin, zinc, antimony or mixtures thereof. In another aspect, alone or in combination with any previous aspects, the nanocomposite has a refractive index of 1.55 to about 1.80, In another aspect, alone or in combination with any previous aspects, the nanocomposite comprises a polyalkylsiloxane, polyphenylsiloxane, polyalkyl-phenylsiloxane, epoxy resin, glass, sol-gel, aerogel, or an optically stable polymer and the one or more nanoparticles are diamond, silicon carbide, calcium titanate, oxides of one or more of zirconium, hafnium, yttrium, titanium, tin, zinc, antimony or mixtures thereof. In another aspect, alone or in combination with any previous aspects, the polymer matrix is a two-part curable resin. In another aspect, alone or in combination with any previous aspects, the composition further comprises nanoparticles and/or microparticles of light-diffusing agents, spectral notch filters, or wavelength shifting agents.

In one aspect, the polymer matrix is a polysiloxane polymer, or one or more precursor components, blends, or copolymers thereof. In another aspect, alone or in combination with any of the previous aspects, the one or more coupling agents comprise one or more chemical functional groups and one or more ligands and/or one or more ligands providing compatibility with the polymer matrix. In another aspect, alone or in combination with any of the previous aspects, the polymer matrix comprises one or more functional groups capable of reacting with the one or more chemical functional groups of the one or more coupling agents. In another aspect, alone or in combination with any of the previous aspects, the one or more nanoparticles are coupled to the one or more coupling agents and/or the polymer matrix. The nanoparticles can be light-diffusing agents, spectral filtering agents, or wavelength shifting agents. In another aspect, alone or in combination with any of the previous aspects, the composition is a curable coating, film, layer, or shape.

In a second embodiment, a method of dispersing a polymer matrix in one or more nanoparticles is provided. The method comprising contacting one or more nanoparticles dispersed in a liquid medium with: (i) one or more coupling agents, the coupling agents having one or more chemical functional groups and one or more ligands; and/or (ii) a polymer matrix; and dispersing the polymer matrix in the nanoparticles, the nanoparticles present in an amount greater than 10 volume percent. In a first aspect, the one or more coupling agents are contacted with the one or more nanoparticles prior to contacting with the polymer matrix. In another aspect, alone or in combination with any previous aspects, the one or more coupling agents are contacted with the polymer matrix prior to contacting with the one or more nanoparticles. In another aspect, alone or in combination with any previous aspects, the one or more chemical functional groups chemically react with the one or more nanoparticles and/or the polymer matrix. In another aspect, alone or in combination with any previous aspects, the polymer matrix comprises one or more precursor components capable of curing, the method further comprising curing the polymer matrix and forming a coating, film, layer, or shape. In another aspect, alone or in combination with any previous aspects, the dispersed nanoparticles are present in the polymer matrix in an amount greater than 50 weight percent. In another aspect, alone or in combination with any previous aspects, the one or more nanoparticles are diamond, silicon carbide, calcium titanate, oxides of one or more of zirconium, hafnium, yttrium, titanium, tin, zinc, antimony or mixtures thereof. In another aspect, alone or in combination with any previous aspects, the coupling agent comprises silicon, germanium, or tin. In another aspect, alone or in combination with any previous aspects, the functional groups are one or more of carboxyl, hydroxyl, amino, or thiol. In another aspect, alone or in combination with any previous aspects, the ligands are one or more of vinyl, acryl, methacryl, or hydride. In another aspect, alone or in combination with any previous aspects, the polymer matrix is a polyakylsiloxane, polyphenylsiloxane, or polyalkyl-phenylsiloxane.

In a third embodiment, a light-emitting device is provided comprising at least one LED configured to emit light responsive to a voltage applied thereto; a nanocomposite at least partially encapsulating the at least one LED, the nanocomposite comprising a first polymer matrix dispersed in at least 10 volume percent of one or more first nanoparticles. In another aspect, alone or in combination with any previous aspects, the one or more first nanoparticles are present at more than about 10 volume percent to less than 99 volume percent. In another aspect, alone or in combination with any previous aspects, the one or more first nanoparticles are present at about 50 weight percent to less than 99 weight percent. In another aspect, alone or in combination with any previous aspects, at least a portion of the one or more first nanoparticles comprise one or more coupling agents, the one or more coupling agents comprising one or more chemical functional groups associated with the one or more first nanoparticles or the first polymer matrix; and one or more ligands providing compatibility with the first polymer matrix. In another aspect, alone or in combination with any previous aspects, the first polymer matrix comprises one or more functional groups coupled with the one or more chemical functional groups of the one or more coupling agents. In another aspect, alone or in combination with any previous aspects, the one or more first nanoparticles are coupled to the one or more coupling agents and the first polymer matrix. In another aspect, alone or in combination with any previous aspects, the one or more first nanoparticles comprise diamond, silicon carbide, calcium titanate, oxides of one or more of zirconium, hafnium, yttrium, titanium, tin, zinc, antimony, or mixtures thereof. In another aspect, alone or in combination with any previous aspects, the nanocomposite forms a first layer at least partially encapsulating the at least on LED, and further comprising a second layer at least partially encapsulating or deposited on the first layer, the second layer comprising a second polymer matrix and second particles, the second layer having at least one of a physical, chemical, or functional property different from the first layer. In another aspect, alone or in combination with any previous aspects, the one or more first nanoparticles comprise diamond, silicon carbide, calcium titanate, oxides of one or more of zirconium, hafnium, yttrium, titanium, tin, zinc, antimony, or mixtures thereof; and wherein the second particles comprise diamond, silicon carbide, calcium titanate, oxides of one or more of zirconium, hafnium, yttrium, titanium, tin, zinc, antimony, or mixtures thereof. In another aspect, alone or in combination with any previous aspects, the first polymer matrix or the second polymer matrix, independently, further comprises one or more scattering particles, fillers, light-diffusing agents, spectral notch filters, or wavelength shifting agents. In another aspect, alone or in combination with any previous aspects, the polymer matrix is a polyakylsiloxane, polyphenylsiloxane or polyalkyl-phenylsiloxane, and the one or more firs nanoparticles comprise diamond, silicon carbide, calcium titanate, oxides of one or more of zirconium, hafnium, yttrium, titanium, tin, zinc, antimony, or mixtures thereof. In another aspect, alone or in combination with any previous aspects, the nanocomposite has a refractive index of 1.55 to about 1.80. In another aspect, alone or in combination with any previous aspects, the nanocomposite is configured as a continuous or non-continuous layer, film, coating, or shape. In another aspect, alone or in combination with any previous aspects, the amount of first nanoparticles present provides a measurable increase in luminous output.

### BRIEF DESCRIPTION OF THE DRAWINGS

FIG. 1A depicts agglomerations of nanoparticles without coupling agent.

FIG. 1B depicts a dispersion of nanoparticles with coupling agent embodiment of the present disclosure within a polymer matrix.

FIGS. 2A and 2B depict exemplary methods of chemically attaching a ligand to a nanoparticle surface through a one-step and two-step process embodiments of the present disclosure, respectively.

FIG. 3 depicts a chemical reaction scheme representative of embodiments of the present disclosure.

FIG. 4 is a sectional view of an embodiment of an LED component according to the present disclosure.

FIGS. 5A, 5B, 5C, 5D, 5E, and 5F depict sectional views of various arrangements of a representative embodiment of a reflective layer of the present disclosure with light emitting sources and/or additional layers of materials.

FIGS. 6A, 6B, 6C, 6D, and 6E, depict sectional views of various alternate arrangements of a representative embodiment of the reflective layer of the present disclosure with light emitting sources and/or additional layers of materials.

FIG. 7 is a cross sectional view of a packaged semiconductor light emitting device according to other embodiments of the present disclosure.

FIGS. 8A and 8B are a cross-sectional side views illustrating a light emitting device package according to further embodiments of the present disclosure.

### DETAILED DESCRIPTION

Embodiments of the present disclosure now will be described more fully hereinafter with reference to the accompanying drawings, in which embodiments of the present disclosure are shown. This present disclosure may, however, be embodied in many different forms and should not be construed as limited to the embodiments set forth herein. Rather, these embodiments are provided so that this disclosure will be thorough and complete, and will fully convey the scope of the claims to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated′ listed items.

It will be understood that when an element such as a coating or a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof Unless otherwise defined, all terms (including technical and scientific terms) used herein have the same meaning as commonly understood by one of ordinary skill in the art to which this present disclosure belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

The terms “crosslink” and “crosslinking” as used herein refer without limitation to joining (e.g., adjacent chains of a polymer) by creating covalent or ionic bonds. Crosslinking can be accomplished by known techniques, for example, thermal reaction, chemical reaction or ionizing radiation (for example, UV/Vis radiation, electron beam radiation, X-ray, or gamma radiation, catalysis, etc.).

The phrase “precursor component” is used herein interchangeably with “coating matrix” and “matrix,” and refers without limitation to one or more materials or one or more compositions of matter that are capable of transitioning from a liquid to a solid or gel suitable for use in or with a light emitting device as a coating of, around, or about one or more components of the lighting device.

The phrase “silicone matrix” as used herein is inclusive of one or more of polysilanes, polysilicones, polysiloxanes, polysilazanes, and combinations thereof. Such polymers are inclusive of their respective oligomers, or if a two-part curable matrix is used, their respective precursor components before and/or after curing. Such polymers and/or precursor components can have bimodal or monomodal molecular weight distributions.

The phrase “nanocomposite” as used herein is inclusive of a combination of one or more polymer matrices and one or more nanoparticle compositions therein. The combination encompasses a physical blending, dispersion, disbursement, and/or distribution of the one or more nanoparticles with and/or within the one or more polymer matrices. The nanoparticles can be chemically the same and can be of the same average particle size, or they may be of different chemical composition and/or different average particle size.

The terms “LED” and “LED device” as used herein may refer to any solid-state light emitter. The terms “solid state light emitter” or “solid state emitter” may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials.

A solid-state lighting device produces light (ultraviolet, visible, or infrared) by exciting electrons across the band gap between a conduction band and a valence band of a semiconductor active (light-emitting) layer, with the electron transition generating light at a wavelength that depends on the band gap. Thus, the color (wavelength) of the light emitted by a solid-state emitter depends on the materials of the active layers thereof. In various embodiments, solid-state light emitters may have peak wavelengths in the visible range and/or be used in combination with lumiphoric materials having peak wavelengths in the visible range. Multiple solid state light emitters and/or multiple lumiphoric materials (i.e., in combination with at least one solid state light emitter) may be used in a single device, such as to produce light perceived as white or near white in character. In certain embodiments, the aggregated output of multiple solid-state light emitters and/or lumiphoric materials may generate warm white light output having a color temperature range of from about 2200K to about 6000K.

Embodiments of the present disclosure will now be described, generally, with reference to GaN-based LEDs on SiC-based or sapphire (Al₂O₃)-based substrates. The present disclosure, however, is not limited to such strictures. Examples of solid-state light emitters such as light-emitting devices that may be used in embodiments of the present disclosure include, but are not limited to, LEDs and/or laser diodes, such as devices manufactured and sold by Cree, Inc. of Durham, N.C. For example, the present invention may be suitable for use with LEDs and/or lasers as described in U.S. Pat. Nos. 8,669,573, 7,952,115, 7,868,343, 6,201,262, 6,187,606, 6,120,600, 5,912,477, 5,739,554, 5,631,190, 5,604,135, 5,523,589, 5,416,342, 5,393,993, 5,338,944, 5,210,051, 5,027,168, 5,027,168, 4,966,862 and/or 4,918,497, the disclosures of which are incorporated herein by reference as if set forth fully herein. Other suitable LEDs and/or lasers are described in U.S. patent application Ser. No. 10/140,796, entitled “GROUP III NITRIDE BASED LIGHT EMITTING DIODE STRUCTURES WITH A QUANTUM WELL AND SUPERLATTICE, GROUP III NITRIDE BASED QUANTUM WELL STRUCTURES AND GROUP III NITRIDE BASED SUPERLATTICE STRUCTURES”, filed May 7, 2002, as well as U.S. patent application Ser. No. 10/057,821, filed Jan. 25, 2002 entitled “LIGHT EMITTING DIODES INCLUDING SUBSTRATE MODIFICATIONS FOR LIGHT EXTRACTION AND MANUFACTURING METHODS THEREFOR” the disclosures of which are incorporated herein as if set forth fully. Furthermore, phosphor coated LEDs, such as those described in U.S. patent application Ser. No. 10/659,241 entitled “PHOSPHOR-COATED LIGHT EMITTING DIODES INCLUDING TAPERED SIDEWALLS, AND FABRICATION METHODS THEREFOR,” filed Sep. 9, 2003, the disclosure of which is incorporated by reference herein as if set forth full, may also be suitable for use in embodiments of the present invention.

The solid-state light emitters and/or lasers may be configured to operate in a “flip-chip” configuration such that light emission occurs through the substrate. In such embodiments, the substrate may be patterned so as to enhance light output of the devices as is described, for example, in U.S. patent application Ser. No. 10/057,821, filed Jan. 25, 2002 entitled “LIGHT EMITTING DIODES INCLUDING SUBSTRATE MODIFICATIONS FOR LIGHT EXTRACTION AND MANUFACTURING METHODS THEREFOR” the disclosure of which is incorporated herein by reference as if set forth fully herein.

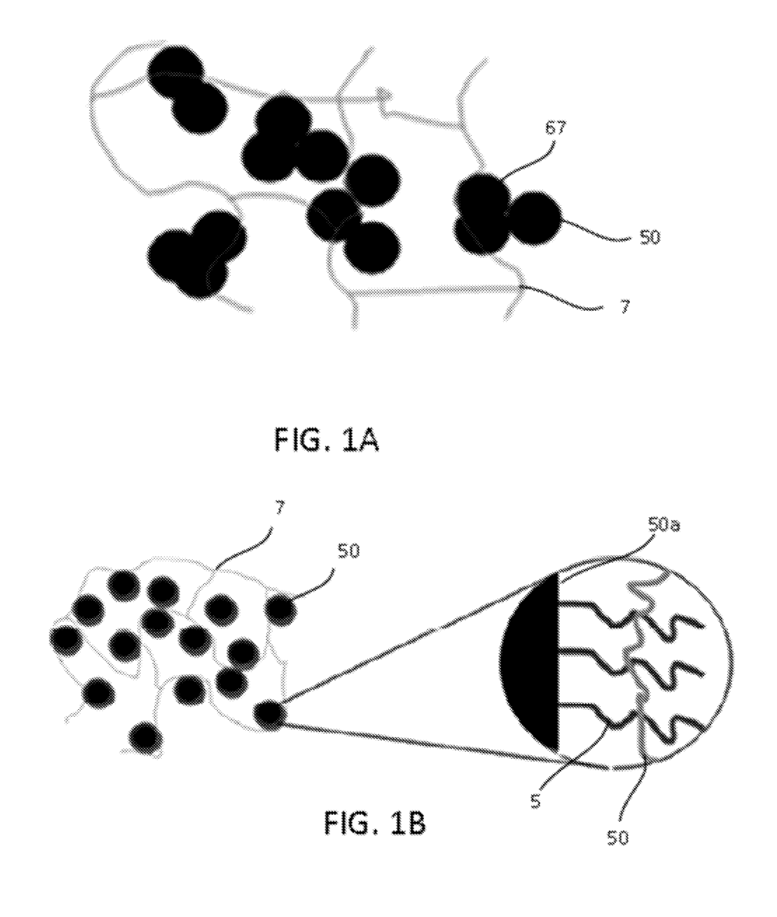

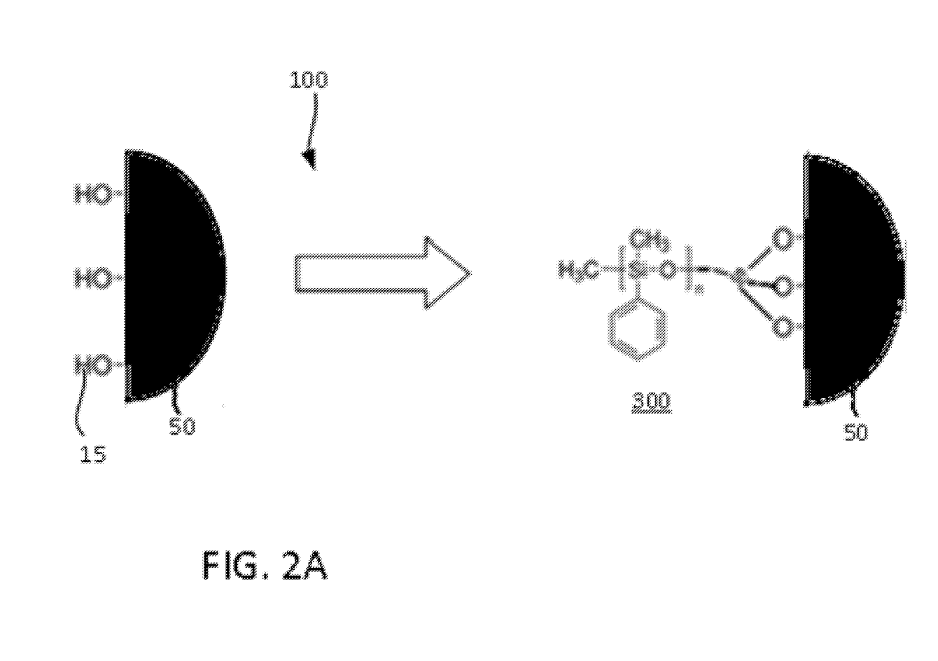

One approach to remedy agglomeration of nanoparticles in polymer matrices is to attach chemical ligands onto the nanoparticles such that they can maintain a certain degree of separation when dispersed within the polymer matrix (see, FIG. 1A). This general approach has certain limitations that are polymer-dependent. For example, dispersion of nanoparticles 50 in a highly hydrophobic polymer matrix 7 such as polysiloxanes has proven difficult, with resultant agglomeration 67 of nanoparticles. Polysiloxane polymers are highly preferred optical materials, for example, for LED applications (devices and/or lighting packages). The present disclosure provides an improvement, as depicted in FIG. 1B, where coupling agent 5 (which can form a “shell” around or couple to at least a portion of surface 50a of nanoparticle 50 and provide favorable interaction with the molecules/polymer chains of polymer matrix 7. Coupling agents 5 also promote favorable dispersion of suspended nanoparticles and deter clustering and agglomeration with neighboring nanoparticles.

The present disclosure provides, among other aspects, a solution to the aforementioned problems of dispersing a high loading (high vol %) of nanoparticles into a polymer, and especially a hydrophobic polymer matrices such as polysilicone and/or polysiloxane matrices, without nanoparticle agglomeration, so as to achieve a nanocomposite with a combination of desirable optical and mechanical properties of the constituent polymer/nanoparticles.

The presently disclosed compositions and methods provide for improved optical and mechanical nanocomposites. Such nanocomposites are useful for improving efficiency gain of LED devices, for example, white-light LED lighting devices. Desirable optical properties of the presently disclosed nanocomposites include high refractive index (e.g., >1.55) and/or high transmittance (clarity) and/or heat resistant properties and/or wavelength shifting and/or spectral filtering properties. Desirable mechanical properties include flexibility and moldability.

Another embodiment, the present disclosure provides a method of using a coupling agent comprising one or more chemical functional groups and one or more ligands or ligand of appropriate chemical composition to promote and/or maintain dispersion of a high loading of nanoparticles in a polymer matrices, such as hydrophobic matrices, for example, polysilicones and/or polysiloxanes. In one aspect, the one or more chemical functional groups are chemically and/or physically coupled to, or reacted with, at least a portion of the nanoparticle surface.

Certain physical properties of silicone nanocomposites applicable to LED lighting devices require a high concentration of nanoparticles to benefit from the nanoparticle properties. However, concentrations that are too high can result in unfavorable nanocomposite properties. If a nanodispersion accepts only a small amount of a given silicone (as described above with commercial dispersions), then very high nanoparticle loadings (>90 vol %) in the overall nanocomposite result. Highly-loaded nanocomposites, although they would possess high refractive indices, are very brittle due to the low silicone concentration and as a result lose the benefit of the polymer matrix that otherwise imparts robustness to the nanocomposite. Thus, loadings of the nanoparticles in silicone matrices are desired in the range of 36-55 vol % to reach sufficiently high refractive indexes, and provide benefit to LED lighting devices. For example, a silicone with a refractive index of 1.5 could be increased to a refractive index of 1.60 to about 1.80, or from 1.57 to 1.76, or from 1.57 to 1.62 within this loading range of a high refractive index nanoparticle.

### Nanoparticles Dispersions

Currently available inorganic nanoparticles dispersions typically are provided in solvents and have the inorganic nanoparticles coated to assist in dispersion. For example, nanodispersions sold by Pixelligent Technologies (www.pixelligent.com) under the PixClear™ product line include zircona nanoparticles with various coatings dispersed in propylene glycol monomethyl ether acetate (PGMEA) with proprietary capping agent. Solid forms of nanoparticles suitable for capping as herein disclosed are available from Such dispersions were evaluated for compatibility with different commercial silicone matrices, but the available ligands that were attached to the zirconia nanoparticle surfaces in the PixClear products provided unsatisfactory low to moderate nanoparticle dispersion within silicone matrices desirable for LED applications. These low to moderate nanoparticles dispersions in such silicone-based polymer matrices result in overall nanoparticle loadings that are too high (64 vol %) for stable films and coatings, as discussed above. While not being held to any particular theory, it has been observed that at least about 10 to about 20 vol % of one component in a nanocomposite is desirable in order to retain some of each component's original properties and/or provide synergistic combinations thereof. By way of example, adding a silicone matrix dropwise to a commercial nanoparticle dispersion caused agglomeration of the nanoparticles, as evidenced by the hazy appearance of the mixture. In extreme cases, the agglomerations were large enough to result in agglomerated nanoparticles settling/precipitating out of the mixture. In these evaluations, approximately 3.0-10.0 vol % of silicone matrix was added to the nanoparticle dispersion, which may not be ideal in order to maintain some of the silicone polymer optical properties, as discussed further below.

### Light-Diffusing, Light-Filtering, and Phosphor NanoParticles

In one aspect, the nanoparticles of the present disclosure can provide light diffusing. Alternatively, the light diffusing particles can be microparticles used with or separately from the nanocomposite. Suitable light diffusing nanoparticles include silicates, silicon dioxide, fused or fumed silica, zinc oxide, zinc sulfide, aluminum oxide, titanium oxide, and the like.

In one aspect, the nanoparticles of the present disclosure are wavelength shifting compounds i.e., phosphors. Phosphors include, for example, commercially available YAG:Ce, although a full range of broad yellow spectral emission is possible using conversion particles made of phosphors based on the (Gd,Y)₃(Al,Ga)₅O₁₂:Ce system, such as the Y₃Al₅O₁₂:Ce (YAG). Other yellow phosphors that can be used for white-light emitting LED chips include, for example: Tb₃₋ₓREₓO₁₂:Ce(TAG), where RE is Y, Gd, La, Lu; or Sr_{2-x-y}BaₓCa_{y}SiO₄:Eu.

Some phosphors appropriate for LEDs can comprise, for example, silicon-based oxynitrides and nitrides for example, nitridosilicates, nitridoaluminosilicates, oxonitridosilicates, oxonitridoaluminosilicates, and sialons. Some examples include: Lu₂O₃:Eu³⁺ (Sr₂₋ₓLaₓ)(Ce₁₋ₓEuₓ)O₄Sr₂Ce₁₋ₓEuₓO₄Sr₂₋ₓEuₓCeO₄SrTiO₃:Pr³⁺, Ga³⁺CaAlSiN₃:Eu²⁺Sr₂Si₅N₈:Eu²⁺as well as SrₓCa₁₋ₓS:EuY, where Y is halide; CaSiAlN₃:Eu; and/or Sr_{2-y}Ca_{y}SiO₄:Eu. Other phosphors can be used to create color emission by converting substantially all light to a particular color. For example, the following phosphors can be used to generate green light: SrGa₂S₄:Eu; Sr_{2-y}Ba_{y}SiO₄:Eu; or SrSi₂O₂N₂:Eu.

By way of example, each of the following phosphors exhibits excitation in the UV emission spectrum, provides a desirable peak emission, has efficient light conversion, and has acceptable Stokes shift, for example: Yellow/Green: (Sr,Ca,Ba)(Al,Ga)₂S₄:Eu²⁺Ba₂(Mg,Zn)Si₂O₇:Eu²⁺Gd_{0.46}Sr_{0.31}Al_{1.23}OₓF_{1.38}:Eu²⁺_{0.06} (Ba_{1-x-y}SrₓCa_{y})SiO₄:Eu Ba₂SiO₄:Eu²⁺.

One or more phosphors can be used so as to provide at least one of blue-shifted yellow (BSY), blue-shifted green (BSG), blue-shifted red (BSR), green-shifted red (GSR), and cyan-shifted red (CSR) light. Thus, for example, a blue LED with a yellow emitting phosphor radiationally coupled thereto and absorbing some of the blue light and emitting yellow light provides for a device having BSY light. Likewise, a blue LED with a green or red emitting phosphor radiationally coupled thereto and absorbing some of the blue light and emitting green or red light provides for devices having BSG or BSR light, respectively. A green LED with a red emitting phosphor radiationally coupled thereto and absorbing some of the green light and emitting red light provides for a device having GSR light. Likewise, a cyan LED with a red emitting phosphor radiationally coupled thereto and absorbing some of the cyan light and emitting red light provides for a device having CSR light.

A combination of BSY and red LED devices referred to above can be used to make substantially white light (referred to as a BSY plus red or “BSY+R” system). A further detailed example of using groups of LEDs emitting light of different wavelengths to produce substantially white light can be found in issued U.S. Pat. No. 7,213,940, which is incorporated herein by reference.

In one aspect, the nanoparticles of the present disclosure are light filtering agents. Light filtering agents may be used to provide a spectral notch. A spectral notch occurs is when a portion of the color spectrum of light passing through a medium is attenuated, thus forming a “notch” when the light intensity of the light is plotted against wavelength. Depending on the type or composition of glass or other spectral notch material used to form or coat the enclosure, the amount of light filtering agent present, and the amount and type of other trace substances in the enclosure, the spectral notch can occur between the wavelengths of 520 nm and 605 nm. In some embodiments, the spectral notch can occur between the wavelengths of 565 nm and 600 nm. In other embodiments, the spectral notch can occur between the wavelengths of 570 nm and 595 nm. Such systems are disclosed in U.S. patent application Ser. No. 13/341,337, filed Dec. 30, 2011, titled “LED Lighting Using Spectral Notching” which is incorporated herein by reference in its entirety. Examples of light filtering agents include, one or more lanthanide elements or lanthanide compounds or neodymium compounds and equivalents coated on or doped (incorporated in) the enclosure, the light-filtering agent is present at a loading sufficient to provide spectral notching. In other aspects, the light-filtering agent can be powder-coated on the interior surface of the enclosure, or the enclosure can be doped with the light-filtering agent or be contained in at least a portion of the thickness of the enclosure separating the interior and exterior surfaces of the enclosure. In yet other examples, the light-filtering agent can be included in a silicone matrix as described above, or as disclosed in co-assigned U.S. patent application Ser. No. 13/837,379, filed Mar. 15, 2013, entitled “RARE EARTH OPTICAL ELEMENTS FOR LED LAMP,” which is incorporated herein by reference in its entirety. In other aspects, the light-filtering agent can be coated on the interior or exterior of the enclosure, independently or in combination with the coating comprising light diffusing particles or other coatings or layers.

By way of example, the silicone nanocomposite of the present disclosure can comprise nanoparticles of one or more rare earth (or lanthanide) compound or element (collectively “REE”) as the light-filtering agent. Thus, in one aspect, the REE is nanoparticles comprising one or more of a lanthanide compound or element, or compound of a rare earth element, such as an oxide, nitride, e.g., neodymium oxide (or neodymium sesquioxide). Other light-filtering agents can be used, such as, neodymium(III) nitrate hexahydrate (Nd(NO₃)₃. 6H₂O); neodymium(III) acetate hydrate (Nd(CH₃CO₂)₃.xH₂O); neodymium(III) hydroxide hydrate (Nd(OH)₃); neodymium(III) phosphate hydrate (NdPO₄.xH₂O); neodymium(III) carbonate hydrate (Nd₂(CO₃)₃.xH₂O); neodymium(III) isopropoxide (Nd(OCH(CH₃)₂)₃); neodymium(III) titanante (Nd₂O₃ titanate.xTiO₂); neodymium(III) chloride hexahydrate (NdCl₃. 6H₂O); neodymium(III) fluoride (NdF₃); neodymium(III) sulfate hydrate (Nd₂(SO₄)₃.xH₂O); neodymium(III) oxide (Nd₂O₃); erbium(III) nitrate pentahydrate (Er(NO₃)₃.5H₂O); erbium(III) oxalate hydrate (Er₂(C₂O₄)₃.xH₂O); erbium(III) acetate hydrate (Er(CH₃CO₂)₃.xH₂O); erbium(III) phosphate hydrate (ErPO₄.xH₂O); erbium(III) oxide (Er₂O₃); Samarium(III) nitrate hexahydrate (Sm(NO₃)₃.6H₂O); Samarium(III) acetate hydrate (Sm(CH₃CO₂)₃.xH₂O); Samarium(III) phosphate hydrate (SmPO₄.xH₂O); Samarium(III) hydroxide hydrate (Sm(OH)₃. xH₂O); samarium(III) oxide (Sm₂O₃); holmium(III) nitrate pentahydrate (Ho(NO₃)₃.5H₂O); holmium(III) acetate hydrate ((CH₃CO₂)₃Ho.xH₂O); holmium(III) phosphate (HoPO₄); and holmium(III) oxide (Ho₂O₃). Other REE compounds, including organometallic compounds of neodymium, didymium, dysprosium, erbium, holmium, praseodymium and thulium can be used. In another example, the silicone nanocomposite can comprise nanoparticles of alexandrite (BeAl₂O₄). Certain REE's can be used to selectively filter light from one or more LED's and/or improve color rendering index (CRI) of lighting devices.

In one aspect of the present disclosure, volume percent loadings of nanoparticles in a silicone matrix are in the range of 10 to about 99 vol %, or about 30 vol % to about 90 vol %, or about 50 vol % to about 80 vol % or about 60 vol % to about 75 vol % so as to provide nanocomposites having sufficiently high refractive indexes. For example, a silicone matrix with refractive index of about 1.5 can be increased to about 1.55 to about 1.80, or to about 1.60 to about 1.75, or about 1.57 to about 1.62 within this nanoparticle loading range as further discussed below.

In certain aspects, the nanocomposite of the present disclosure comprises one or more precursor components that independently or in combination comprise one or more of nanoparticles capable of a light-diffusing and/or light-filtering and/or wavelength shifting. Thus, in any one or more of the aforementioned precursor component embodiments or their resultant coating, a light-diffusing nanoparticle and/or light-filtering nanoparticle and/or phosphor (wavelength shifting) nanoparticle can be added, dispersed, distributed, incorporated therein, associated therewith, and/or combined. It is understood that any of the previously described coatings or layers can be used alone or be used with other coatings or layers, which can be deposited on and/or between other coatings or layers.

The nanoparticles can comprise, for example, nanoparticles with a high index of refraction or wavelength conversion properties, or both. In one aspect, the nanoparticles comprise zirconia, diamond, boron nitride, aluminum nitride, aluminum oxide, tin oxide, titanium dioxide, silicon carbide, calcium titanate, antimony oxide, zinc oxide and materials used for wavelength shifting quantum dots, such as CdSe, CdTe, ZnS, GaInP, etc. The surface of the nanoparticles can be pretreated or prepared to facilitate association and/or chemical reaction with the polymer matrix. The presently disclosed nanocomposites typically comprises a polymer matrix having a first index of refraction, and first nanoparticles having a second index of refraction differing from the polymer matrix by about 0.3 to about 1.5 or larger. In one aspect, the index of refraction of the nanoparticles can be between about 1.8 to about 2.9.

The average particle size of the nanoparticles can be between about 0.001 nanometer to about 750 nanometers. In preferred embodiments, the nanoparticles have an average particle size distribution between about 1 nm and 100 nm, or between about 5 nm to about 50 nm, depending on the nanoparticle, coupling agent, solvent system, and polymer matrix combination used. The nanoparticles can be added alone or in combination with other components, such as the phosphor or light-filtering agents, which can be nano- and/or micro-particles, and added to the curable coating, e.g., to either part Part A and/or Part B, or to both parts of a two-part curable coating).

The nanoparticles can be present between about 25 volume percent to about 99 volume percent, between about 30 to about 90 volume percent, or between about 50 to about 80 volume percent, or between about 65 to about 75 volume percent with respect to the index of refraction desired.

Nanoparticle dispersions of the above compounds can be prepared using conventional methods such as ultra-high shear mixing, ultrasonic disruptive mixing, grinding, ball or jet milling, etc. using appropriate solvents and/or polymeric systems. In one aspect, the solvent is compatible or miscible with the silicone matrix or its one or more precursor components. The one or more coupling agents and/or polymer matrix can be introduced to the particles prior to forming nanoparticles therefrom or added simultaneously with the particles to the polymer matrix.

### Coupling Agents

In an embodiment, the present disclosure provides for methods to physically and/or chemically incorporate the coupling agents to at least a portion of the nanoparticle surface. In a first aspect, the method involves the use of a multi-functional coupling agent. An example of a multi-functional coupling agent includes, for example, reactive groups, such as acrylate, methacrylate, acrylamide, methacrylamide, fumarate, maleate, norbornenyl and styrene functional groups, Si—H (silicon hydride), hydroxy, alkoxy, amine, chlorine, epoxide, isocyanate, isothiocyanate, nitrile, vinyl, and thiol functional groups. In one example, the coupling agent comprises an organosilane moiety with one, two or three chemical leaving groups (for example, alkoxyl, (methoxy, ethoxy, etc.) halogen (e.g. chloro, etc.) that can interact and/or covalently bond with polar surface groups of the nanoparticles (for example hydroxyl, amino, thiol, carboxyl, etc.), the remainder of the organosilane moiety having one or more ligand groups being nonreactive or non-interactive with the nanoparticle surface. Similar multi-functional compounds of germanium can be used.

In one aspect, the coupling agent comprises one or more chemical functional groups and one or more ligands to promote dispersion of the nanoparticles into polymer matrix and are described herein by way of example using organosilane moieties. The ligands of the organosilane moiety should contain specific chemical groups that are chemically similar to those present in the silicone polymer matrix. For example with methylsiloxane polymers, methyl-based siloxane ligands would work best due to chemical similarity. Methylphenyl-based siloxane's can contain methylphenyl-based siloxane ligands with a similar Ph:Me ratio along the backbone. Furthermore, coordinating the spatial distribution of the methyl and phenyl groups on the ligands to that of the matrix would impart even greater dispersability. Examples of methyl and phenyl backbone structures include block, syndiotactic, and atactic. In all cases, by using a chemically similar siloxane ligands with the matrix, there will be better compatibility and fewer agglomerations, providing a nanocomposite of good visible light transparency and high index of refraction functionality.

The molecular weight of the organosilane moiety can range from less than hundred Daltons to thousands or hundreds of thousands of Daltons. The molecular weight necessary to reach optimized dispersibility or distribution depends on many factors, including the composition and shape of the nanoparticle itself, the relative difference in chemical composition of the ligand and silicone matrix and the need for secondary reactivity of the ligand into the matrix. Extremely low molecular weight ligands may not provide sufficient interactions between polymer chains and ligand molecules, especially if the chemical composition of the ligand and silicone matrix are not well matched. Excessively long-chained ligands could lead to difficulty in reacting the ligand to the silicone matrix due to entropic effects. In one aspect, organosilane moiety molecular weights can vary from 80-5,000 Daltons (Da), but in one aspect, a range of molecular weights can be from about 300 Da to about 2500 Da.

To obtain certain desirable physical properties of silicone nanocomposites, a high concentration of nanoparticles may be required to realize the benefit from the nanoparticle properties. On the other hand, nanoparticle concentrations that are too high can result in unfavorable nanocomposite film properties rendering them undesirable for certain LED applications. If a nanodispersion accepts only a small amount of a given silicone polymer matrix (as discussed above with commercial nanoparticle dispersions), then very high nanoparticle loadings (>90 vol %) in the overall nanocomposite result. Highly-loaded nanocomoposites, while possibly possessing high refractive indices, provide very brittle films and/or coatings due to the low silicone concentration.

### Polymer Matrices

The presently disclosed nanocomposites can be prepared by combining a polymer matrix, coupling agent, and nanoparticle dispersions, as herein disclosed. Combining, as that word is used herein, is inclusive of distributive or dispersive mixing and/or stirring, shearing, sonicating, tumbling, and the like.

In one embodiment, the polymer matrix comprises a silicone-based polymer. Siloxane polymers or silicones are highly preferred optical materials for LED applications and are particularly difficult matrices in which to incorporate a high loading (>10 vol %) of dispersed nanoparticles, especially without appropriate ligands for sufficient compatibility. The mixed polarity typical of silicones (ionic, hydrophilic Si—O backbone and hydrophobic side groups), limits the use of many standard ligands that are generally either very hydrophobic (aliphatic groups) or very hydrophilic (ionic groups). The present disclosure provides methods for promoting the dispersion of nanoparticles (organic or inorganic) into silicone polymer matrices, and to prevent the agglomeration of the nanoparticles at high concentrations. In particular, the method consists of choosing the appropriate ligands to attach to the nanoparticle surfaces in order to achieve high nanoparticle loadings.

In certain aspects, the curable silicone matrix is a one- or two-part-curable formulation comprising one or more precursor components, independently or jointly, comprising the nanoparticle dispersion. In one aspect, the precursor component is any one or more precursors that are suitable for and capable of providing an optically transparent coating for use in a lighting device. In another aspect, the precursor component comprises one precursor. In another aspect, the precursor component is comprised of a “two-part composition.” The precursor component provides for a cured or set coating optionally with other components. The cured or set coatings or films or shapes prepared from the precursor components includes, sol-gels, gels, glasses, cross-linked polymers, and combinations thereof.

In one embodiment, the silicon nanocomposite comprises a silicone-based polymer configured to receive a nanoparticle dispersion. In one aspect, the silicon nanocomposite provides a light transmissive coating, a wavelength shifting coating, a spectral notch coating, a light diffusing coating, or combinations thereof, including single and multiple layers of the silicone nanocomposite.

Examples of cured or set silicone matrixes formed from the one or more precursor components include, for example, one or more polymers and/or oligomers of silicones, e.g., polysiloxanes (e.g., polydialklysiloxanes (e.g., polydimethylsiloxane “PDMS”), polyalkylaryl siloxanes and/or polydiarylsiloxanes), and/or copolymers thereof, or such materials in combination with other components.

Examples of silicone matrices suitable for LED coatings include, without limitation, LPS-1503, LPS-2511, LPS-3541, LPS-5355, KER-6110, KER-6000, KER-6200, SCR-1016, ASP-1120, ASP-1042, KER-7030, KER-7080 (Shin-Etsu Chemical Co., Ltd, Japan); QSil 216, QSil 218, QSil 222, and QLE 1102 Optically Clear, 2-part Silicone coating (ACC Silicones, The Amber Chemical Company, Ltd.), United Kingdom); LS3-3354 and LS-3351 silicone coatings from NuSil Technology, LLC (Carpinteria, Calif.); TSE-3032, RTV615, (Momentive Potting Silicone, Waterford, N.Y.); OE-6630, OE-6631, OE-6636, OE-6336, OE-6450, OE-6652, OE-6540, OE-7630, OE-7640, OE-7620, OE-7660, OE-6370M, OE-6351, OE-6570, JCR-6110, JCR-6175, EG-6301, SLYGUARD silicone elastomers (Dow Corning, Midland, Mich.). Additional examples of optical grade silicones include Dow Corning's™ optical encapsulant OE-6XXX and OE-7XXX series of methyl and phenyl siloxanes (http://www.dowcorning.com/content/etronics/etronicsled/etronicopenst.asp).

In one aspect, the one- or two part-curable precursor component(s) are of low solvent content. In another aspect, the one- or two part-curable precursor component(s) are essentially solvent-free. Essentially solvent-free is inclusive of no solvent and trace amounts of low volatility components, where trace amounts is solvent is present, but at an amount less than 5 weight percent, less than 1 weight percent, and less than 0.5 weight percent.

In one aspect, the coating comprises one or more silicon precursor components, which can comprise siloxane and/or polysiloxane. A number of polysiloxanes, with varying backbone structure are suitable for use as a precursor component. With reference to Equation (1), various forms of polysiloxanes, e.g., the M, T, Q, and D backbones, where R is, independently, alkyl or aryl, are presented:

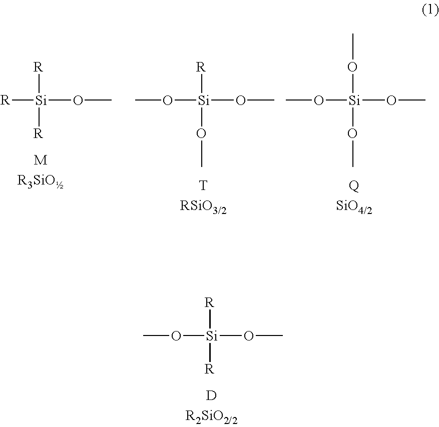

In various aspects, precursor components comprise one or more reactive silicone containing polymers (and/or oligomers or formulations comprising same). Such one or more reactive functional groups can be mixed with non-reactive silicone containing polymers. Examples of reactive silicone containing polymers with reactive groups, include for example, linear or branched polysiloxanes containing at least one acrylate, methacrylate, acrylamide, methacrylamide, fumarate, maleate, norbornenyl and styrene functional groups, and/or linear or branched polysiloxanes with multiple reactive groups such as Si—H (silicon hydride), hydroxy, alkoxy, amine, chlorine, epoxide, isocyanate, isothiocyanate, nitrile, vinyl, and thiol functional groups. Some specific examples of such linear or branched polysiloxanes include hydride-terminated, vinyl-terminated or methacrylate-terminated polydimethyl siloxanes, polydimethyl-co-diphenyl siloxanes and polydimethyl-co-methylphenylsiloxanes. The reactive groups can be located at one or both terminuses of the reactive silicone polymers, and/or anywhere along the backbone and/or branches of the polymer.

In one aspect, an exemplary example of a silicone precursor component comprises linear siloxane polymers, with dimethyl or a combination of methyl and phenyl chemical groups, with one or more reactive “R” chemical groups; where R is independently, hydrogen, vinyl or hydroxyl.

In another aspect, an exemplary example of a silicone precursor component comprises branched siloxane polymers, with dimethyl or a combination of methyl and phenyl chemical groups with one or more reactive “R” chemical groups, where R is independently hydrogen, vinyl or hydroxyl) associated with the precursor component.

In another aspect, an exemplary example of a silicone precursor component comprises linear siloxane polymers, with a combination of methyl, phenyl and hydroxyl or alkoxy chemical groups, with one or more reactive “R” chemical groups where R is hydrogen, vinyl or hydroxyl associated with the precursor component.

In another aspect, an exemplary example of a silicone precursor component comprises branched siloxanes, with any of methyl, phenyl and hydroxyl or alkoxy chemical groups, with one or more reactive “R” chemical groups where R is hydrogen, vinyl or hydroxyl associated with the precursor component.

In one aspect, a curable precursor component alone or with other material can be used specifically for forming coating for a LED lamp, for example, a LED lamp with a glass enclosure surrounding the LEDs and/or electrical components.

In one aspect, one or more polymers and/or oligomers of polysiloxanes are used. The one or more polymers and/or oligomers of polydialklysiloxanes (e.g., polydimethylsiloxane PDMS), polyalkylaryl siloxanes and/or polydiarylsiloxanes can comprise one or more functional groups selected from acrylate, methacrylate, acrylamide, methacrylamide, fumarate, maleate, norbornenyl and styrene functional groups, and/or polysiloxanes with multiple reactive groups such as hydrogen, hydroxy, alkoxy, amine, chlorine, epoxide, isocyanate, isothiocyanate, nitrile, vinyl, and thiol functional groups. Some specific examples of such polysiloxanes include vinyl-terminated-, hydroxyl-terminated, or methacrylate-terminated polydimethyl-co-diphenyl siloxanes and/or polydimethyl-co-methylhydro-siloxanes. In one aspect, the function group is located at one or both terminuses of the precursor component.

In one aspect, precursor components comprising or consisting essentially of silsesquioxane moieties and/or polysilsequioxane moieties can be employed for the coating. Polyhedral oligomeric silsesquioxanes and/or polysilsesquioxanes may be either homoleptic systems containing only one type of R group, or heteroleptic systems containing more than one type of R group. POSS-moieties are inclusive of homo- and co-polymers derived from moieties comprising silsesquioxanes with functionality, including mon-functionality and multi-functionality. Poly-POSS moieties encompass partially or fully polymerized POSS moieties as well as grafted and/or appended POSS moieties, end-terminated POSS moieties, and combinations.

Additional substances in the aforementioned coating or one or more precursor components providing the coating can be used, e.g., platinum catalyst, casting aids, defoamers, surface tension modifiers, functionalizing agents, adhesion promoters, crosslinking agents, viscosity stabilizers, other polymeric substances, and substances capable of modifying the tensile, elongation, optical, thermal, rheological, and/or morphological attributes of the precursor component or resulting coating.

The above compositions can be catalyzed (e.g., for curing) by a platinum and/or rhodium catalyst component, which can be all of the known platinum or rhodium catalysts which are effective for catalyzing the reaction between silicon-bonded hydrogen groups and silicon-bonded olefinic groups.

The curable coating and/or precursor components herein disclosed provide, among other things, light transparent and optionally, high index of refraction silicone nanocomposites as a coating or layer. In one aspect, the silicone nanocomposites are visible light transparent.

Preferably, the nanocomposite herein disclosed provides an index of refraction of about 2.3, about 2.2, about 2.1, about 2.0, about 1.9, about 1.8, or about 1.75. In one aspect, the nanocomposite herein disclosed provides an index of refraction of between about 1.5 to 1.75 using, for example, a two part silicone resin and modified nanoparticles present at high volume percent. In one aspect, the polymeric matrix is transparent (low absorbing, e.g., less than 20%) in the visible spectra and/or at least a portion of the UV region (e.g., from about 200 nanometers to about 850 nanometers). In other aspects, the polymer matrix is transparent in the visible spectra and not transparent (e.g., substantially absorbing, e.g., about 90% or more) in the UV region (e.g., from about 200 nanometers to about 850 nanometers). In one aspect, the polymeric matrix is at least 85% transparent in the visible spectra, at least 90% transparent, or at least 95% transparent corresponding to the wavelength(s) of LED light emitted from an LED package, LED substrate, or LED lighting device. In one aspect, the polymeric matrix is opaque or otherwise not transparent in at least a portion of the visible spectra.

### Methods

The present disclosure provides two alternate methods of attaching the organosilane moiety to the nanoparticles. The nanoparticles can be the same chemical composition or of different chemical compositions. The first method involves direct coupling of the organosilane moiety to the one or more reactive ligands which is then coupled to the surface of the nanoparticles. In the direct approach, the organosilane moiety comprises one or more reactive groups that is capable of coupling to both the one or more reactive ligands and the surface of the nanoparticle. The second method involves indirect indirectly coupling organosilane moiety. In the indirect approach, the surface of the nanoparticle is prepared by contact with an organosilane moiety such that it contains a new specific functionality that can react with the one or more reactive groups of the ligands.

After addition of the chemically compatible ligands to the nanoparticle surface, there are two general types of interactions the ligand can have with the silicone matrix: (1) reactive methyl and methylphenyl ligands and (2) non-reactive methyl and methylphenyl ligands. These ligand types represent molecules that possess chemical compatibility with the host silicone polymer and either can or cannot react into the final cured siloxane network structure, respectively. The reactive ligands would form new covalent bonds to the silicone host polymer as an additional means to promote and/or retain the dispersibility of the nanoparticles into the silicone network.

In one aspect, the present disclosure comprises methods of combining organosilane moieties with nanoparticle dispersions and/or silicone matrices. As discussed above, the organosilane moieties comprise specific ligands that possess chemically similar and/or compatible attributes, such as a phenyl-to-methyl ratio, to that of the silicone matrices to which it is used. For example, organosilane moieties with at least one methyl ligand is matched with a methylsilicone-based silicone matrix, or an organosilane moiety with at least one methylphenyl ligand is matched to a methylphenylsilicone-based silicone matrix. Other combinations of organosilane moieties with particular ligands can be matched with particular silica matrices, such as an organosilane moiety with one or more silane groups matched with a silicon hydride-based silica matrix, or an organosilane moiety with at least one methyl and at least one phenyl group can be matched with a methylphenyl silicone matrix. Other functional groups can be matched, such as vinyl, allyl, etc.

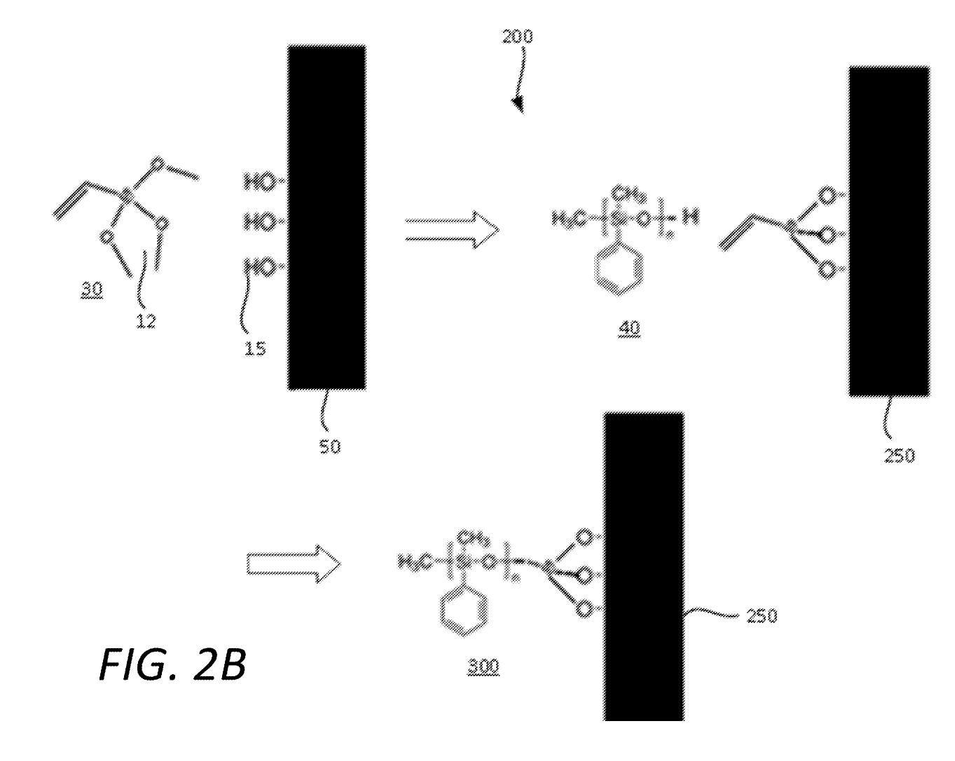

FIG. 2A shows schematically one exemplary embodiment of a “one-step” method 100 that utilizes coupling agent 10 (e.g., organosilane moiety) which possesses one or more reactive groups 12 (e.g., three methoxy groups) and at least one nonreactive siloxane oligomeric ligand 20 (e.g., a single methylphenyl oligomeric group), is shown being introduced to a surface of nanoparticle 50 having one or more chemical functional groups 15 present on its surface that associates with and/or reacts with the one or more reactive groups of organosilane moiety coupling agent 10 to provide a nanocomposite 300. Such methods provide for dispersion of the nanoparticle and to minimize or reduce agglomeration thereof. Nanoparticles 50 of the present disclosure are inclusive of any and all geometrically shapes.

In another exemplary embodiment as shown in FIG. 2B, an example of a “two-step” method 210 comprising an organosilane coupling agent 30, such as vinyltrimethoxysilane, that is initially introduced to the surface of nanoparticle 50 to provide functionalized nanoparticle 250. One or more chemical functional groups 15 present on the surface of nanoparticle 50 associates with and/or reacts with the one or more reactive groups 12 of coupling agent 30 (e.g., organosilane moiety with vinyl group), which may then associate with or react with silicone matrix 40 (e.g., methylphenyl oligomer), having complementary reactive group (e.g., such as a hydride-terminated methylphenyl siloxane) to provide nanocomposite 300 as well as provide dispersion of the nanoparticle and to minimize or reduce agglomeration thereof.

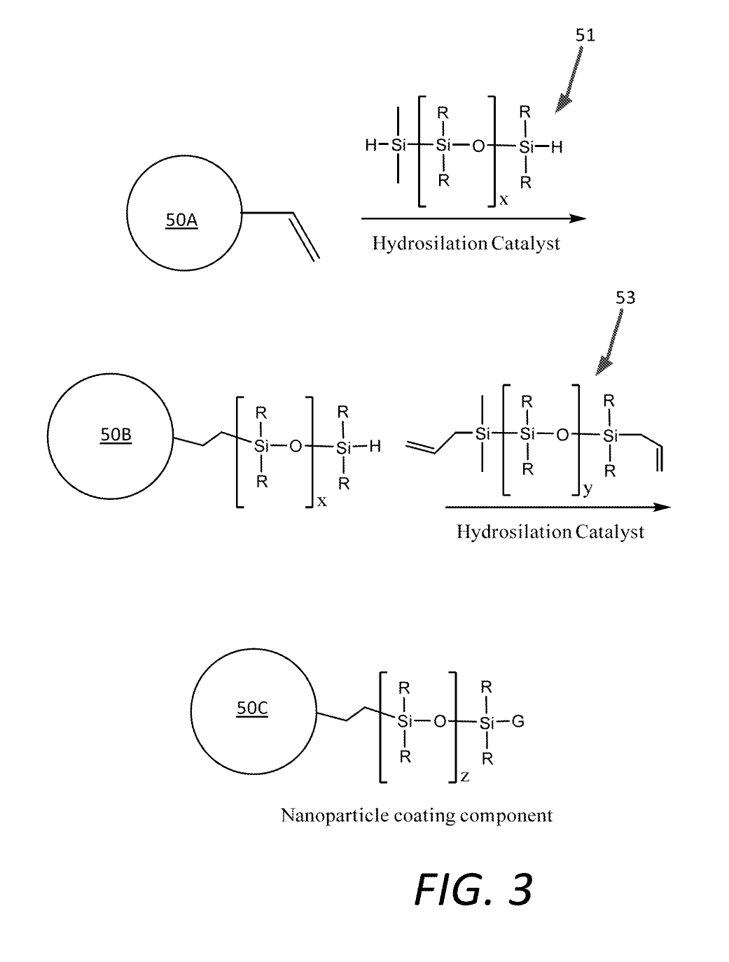

In another exemplary embodiment, a phase change nanocomposite process is employed. In this embodiment, as depicted in FIG. 3, nanoparticles with specific reactive functional groups are combined to disperse and/or distribute the nanoparticles among liquid precursors suitable for use with LED devices. Thus, FIG. 3 depicts similar chemistry to that of FIG. 2B, for example, nanoparticle 50A having vinyl substitution reacted with hydride-oligomer/polymer with catalyst to produce nanoparticle 50B. Nanoparticle 50B can be further reacted with vinyl-oligomer/polymer with catalyst to produce nanoparticle 50C that is suitable for combination with a polymer matrix. The reaction scheme of FIG. 3 can be carried out in a suitable precursor formulation, such one part of a two part curable silicone resin formulation to bring the solid nanoparticles 50A into a liquid phase, for example, 50B or 50C, thus providing a phase changed nanocomposite. Combinations of the methods depicted in FIGS. 2A, 2B, and 3 can be used.

### Lighting Component Examples

In embodiments of the present disclosure, the nanoparticle-polymer matrix composition can be dispersed or dispensed or coated on lighting components. In one aspect, the lighting component is one LED or an array of two or more LEDs of the same or different light emitting wavelengths. The LEDs are typically mounted on a substrate and can include various electrical connections such as wire traces, ESD's, bonding pads, contacts, heat management elements, etc, which can absorb light emitted from the LED or reflect its light in a direction towards such light absorbing features. Using the nanoparticle-polymer matrix composition disclosed herein, light from the one or more LEDs are more effectively reflected out from the lighting component, providing improved efficiency gain for the lighting component. The nanoparticle-polymer matrix composition can be used in combination with other methods, structures, and compositions that increase efficiency of the one or more LEDs.

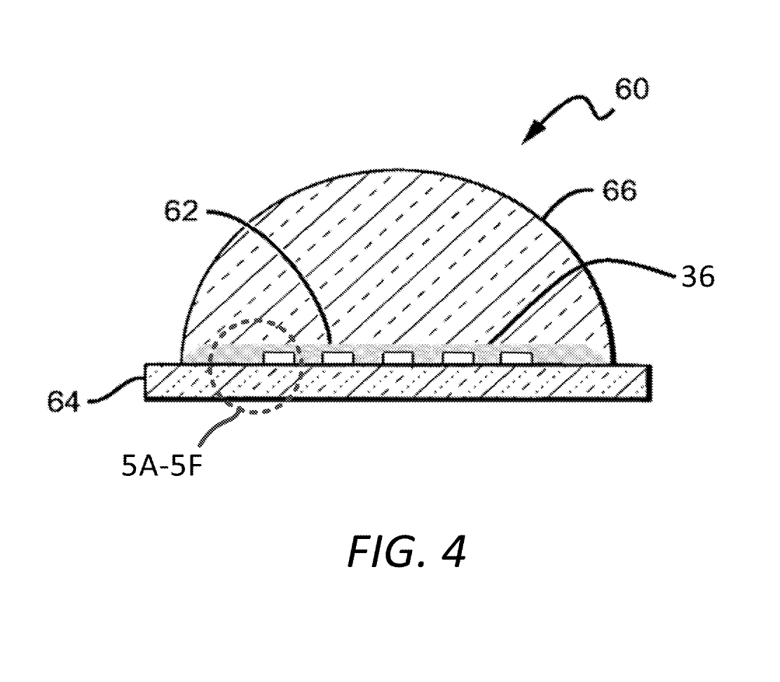

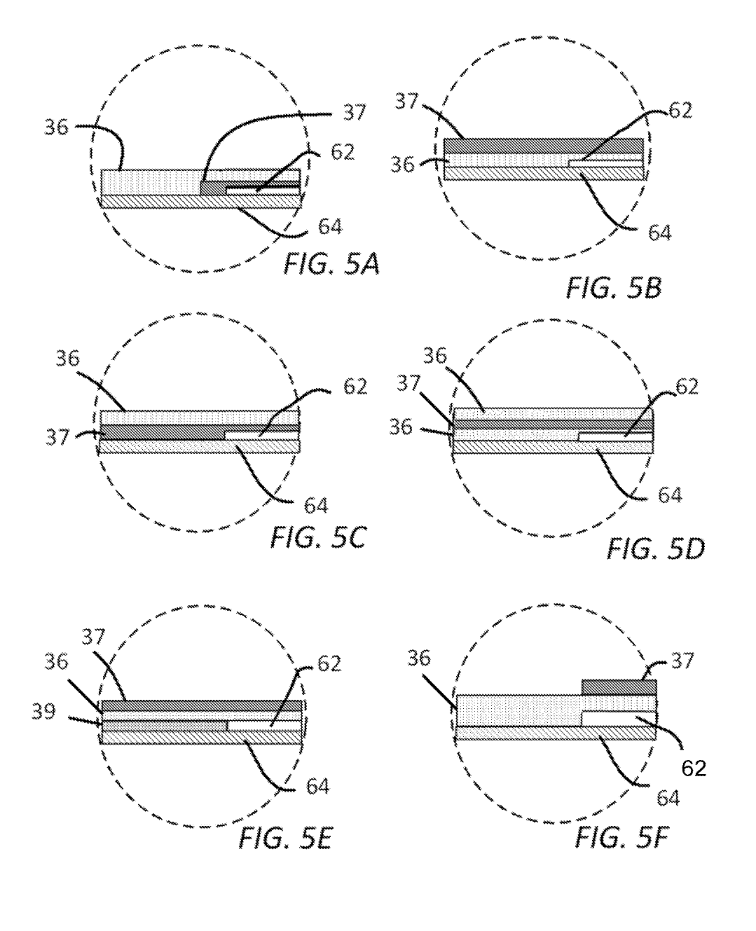

FIG. 4 is a sectional view of an embodiment of an LED component 60 with an optical element 66, showing the nanocomposite of the nanoparticle-polymer matrix composition, hereinafter also referred to as the “layer 36,” formed about an array of LED chips 62, mounted on a substrate surface 64. Exploded section view 5A-5F is described with reference to FIGS. 5A through 5F, where various sectional view of LED component 60 is shown. In a manner as exemplified below in the Examples section, layer 36, comprising the polymer matrix, one or more coupling agents, and nanoparticles, is formed about LED chips 62. The layer 36, which can be deposited by spraying, brushing, dispensing, etc., so as to form a coating, film, or shape, can optionally cover any electrical traces/pads (not shown), or heat transfer material 39, etc. In this exemplary aspect, the layer 36 essentially encapsulates the LED chips 62 as shown, but can be at a height above, below, or equal to any light emitting surface, e.g., top, side, or bottom edges of LED chips 62 (not shown). For example, in one embodiment, the layer 36 is of a thickness corresponding to a height from the substrate that is more than the vertical height of any light emitting surface of the LED elements relative to the substrate surface 64. In other aspects, the layer 36 is non-planar and/or contains planar and/or non-planar sections, or in other aspects, contains angled sections configured to receive the light from the solid state emitter at a predetermined angle. In certain aspects, the layer 36 completely surrounds the LED chips 62, of essentially a planar surface, a toroidal shape, a circular shape, or rectangular or square shape.

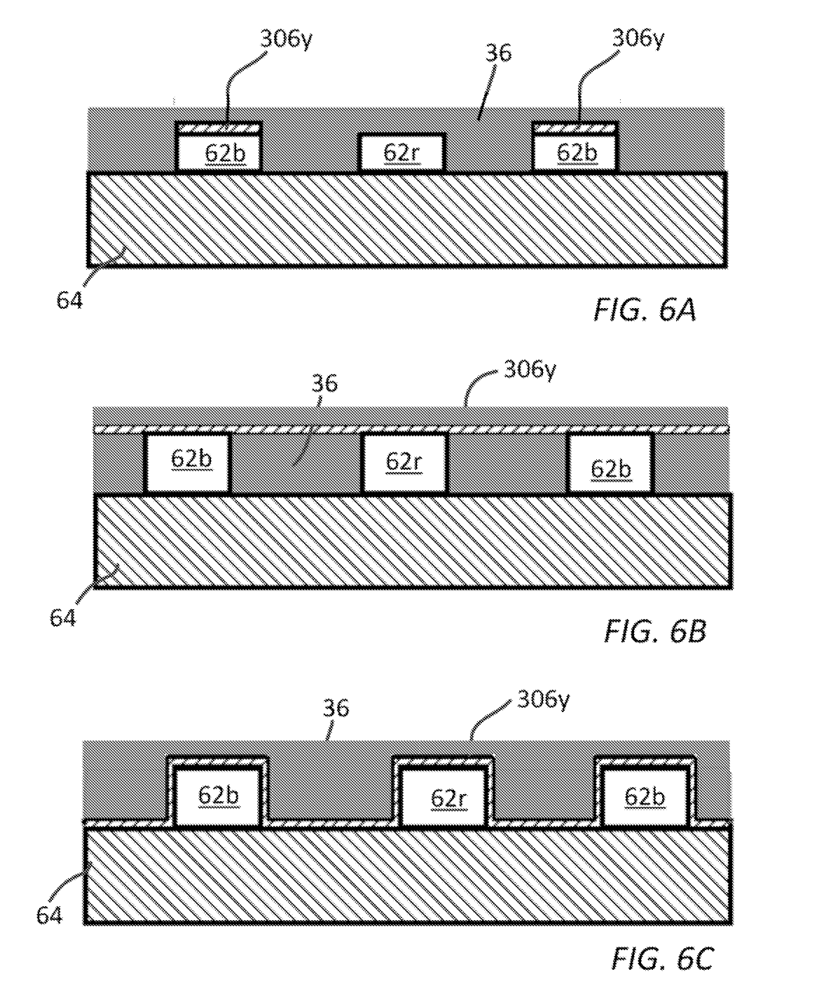

FIGS. 6A, 6B, and 6C depict additional embodiments of arrangements for layer 36 using phosphor coated LEDs. These figures serve as an exemplary embodiment that encompasses any combination of LED/phosphor combination of utility in providing LED lighting devices. Thus, FIG. 6A depicts layer 36 positioned between LEDs (62b, 62r, e.g., a blue light and a red light emitting LED combination) with and without phosphor layer 306y on the light emitting surface thereof. Masking and/or etching techniques can be used to introduce the phosphor to specific LEDs after layer 36 is provided. Alternatively, after layer 36 is provided, a blanket coating of phosphor layer 306y can be mask-removed from the light emitting surfaces of specific LEDs. In other aspects, 3-D printing is used to construct or arrange layer 36 or other layers about the LEDs. Thus, with reference to FIG. 6B, a blanket coating of phosphor layer 306y over layer 36 about LEDs (62b, 62r) is provided. FIG. 6C depicts a conformably phosphor coated arrangement with layer 36 positioned between LEDs (62b, 62r) and covering at least a portion of the phosphor layer 306y.

FIGS. 6D and 6E depict additional embodiments similar to the embodiments of FIGS. 6A and 6B, respectively, having second layer 33 deposited thereon, the second layer at least partially encapsulating or deposited on the layer 36 (or “first layer”), the second layer comprising a second polymer matrix and second particles, the second layer having at least one of a physical, chemical, or functional property different from the first layer. In one aspect, the second layer is deposited directly on the first layer. Second layer 33 is shown deposited over the phosphor layer 306y and LEDs 62b or 62r. Second layer can of course be deposited under layer 36, for example, on the substrate, or remotely on an optical component (not shown). Second layer 33 can comprise the same particles as the layer 36, and/or other nano- or micro-particles, for example, of one or more, independently or in combination, of a different composition of material, different index of refraction, different average particle size of the same or different composition of materials as in layer 36. For example, second layer 33 can comprise a polymer matrix of different refractive index (than that of layer 36) as well as comprising of one or more, independently or in combination, of a different composition of material, different index of refraction, different average particle size of the same or different composition of materials. For example, layer 36 can comprise a polyalkylsiloxane matrix and second layer 33 can comprise a polyalkyl-polyarylsiloxane or polyarylsiloxane matrix. The layer 36 in combination with second layer 33 can be used to adjust efficiency gain to the combination of LED wavelength(s), phosphors, notch filtering materials, substrate, etc. Other layers, e.g., a third layer, fourth layer, etc., can be used and includes combinations of layer 36 and second layer 33, or of layer 36 with second layer 33 and other different layers. The layers, in combination, can provide a gradient RI or have defined regions of transition from one RI to the other RI.

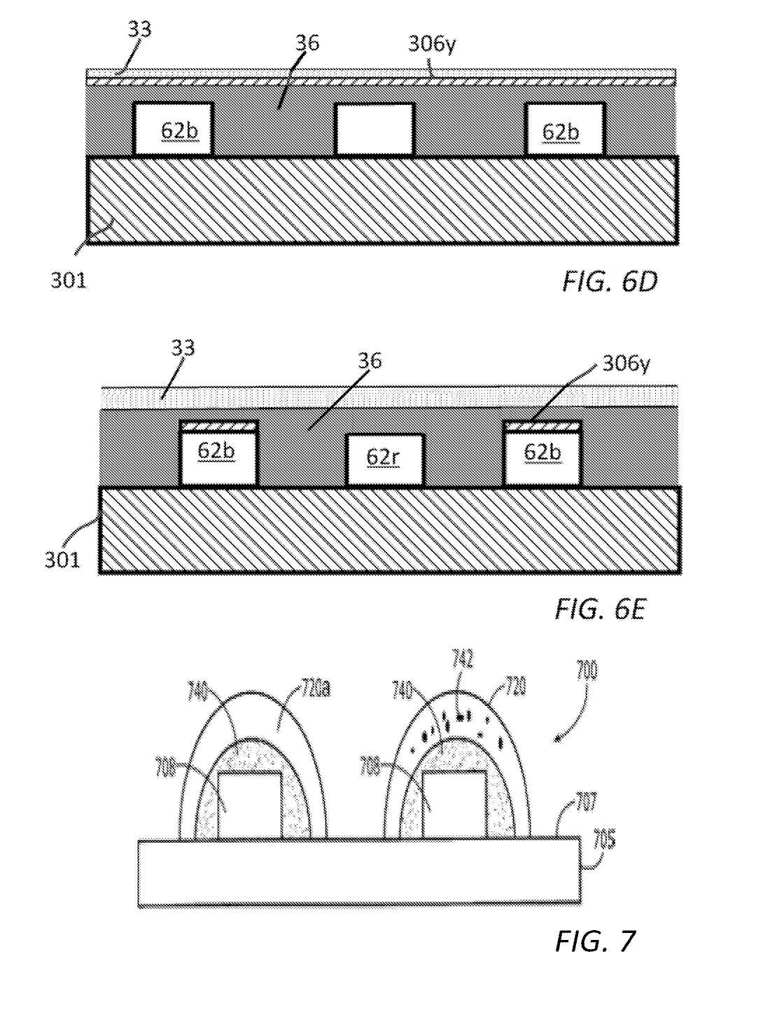

For example, as seen in another embodiment, depicted in FIG. 7, the nanocomposite composition can be used with a packaged semiconductor light emitting device 700 that includes a plurality of semiconductor light emitting devices 708 mounted flush on a front face 707 of a substrate 705. A first nanocomposite 740 is formed over each of the semiconductor light emitting devices 708. A second layer 720 is formed over at least one of the first nanocomposite layer 740 and the semiconductor light emitting device 708. As further shown in the embodiments of FIG. 7, an additive 742 may be added to the second layer 720 to affect the light transmission or emission characteristics of the semiconductor light emitting device 708. As further shown in the embodiments of FIG. 7, the second layer 720a may be without additive 742 to affect the combined light transmission or emission characteristics of the semiconductor light emitting device 708. It will be understood that the additive 742 may instead be added to the first nanocomposite layer 740 or a same and/or different additive may be provided in each of the optical element layers 720, 740. In addition, optical properties may be further tailored by selection of different characteristics for the respective optical element layers 720, 740, for example, selecting a different refractive index for the respective materials to provide a desired effect in passage of light emitting from the semiconductor light emitting device 708. Additives to affect optical properties may include a phosphor, a scatter agent, a luminescent material and/or other material affecting optical characteristics of the emitted light.

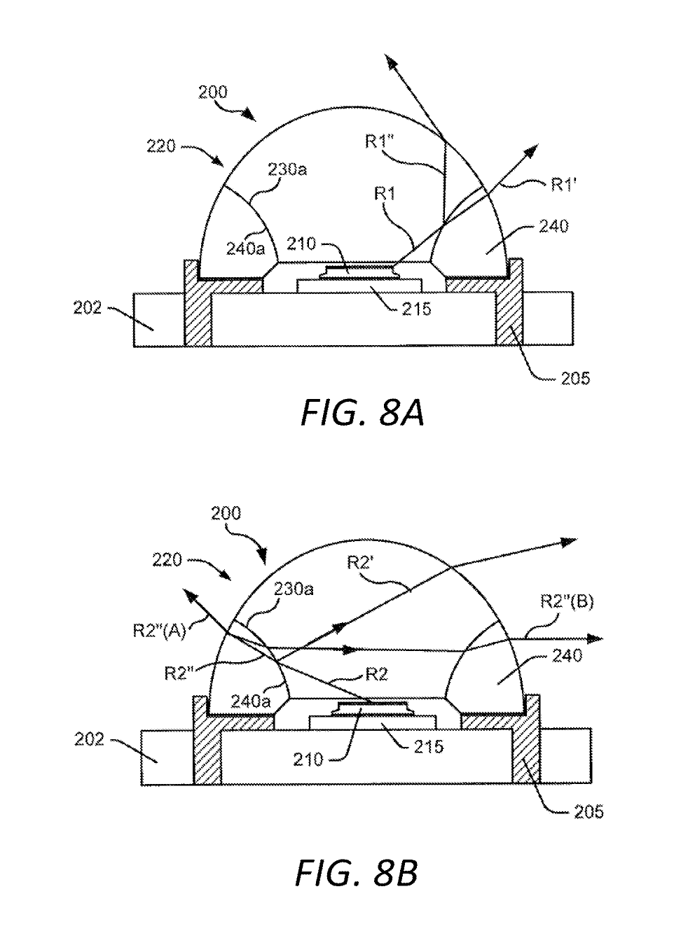

Referring to FIGS. 8A and 8B, a light emitting package 200 is illustrated. The package 200 includes a substrate 202 on which an LED chip 210 is mounted. The LED chip 210 may be provided on a submount 215, and the entire LED/submount assembly may be mounted on the substrate 202. While a single LED chip is shown, it will be understood that more than one LED chip 210 and/or submount 215 may be provided on the substrate 202.

According to some embodiments of the invention, a dual index element 220 is provided about the LED chip 210. The dual index element 220 can be a nanocomposite e.g., layer 36 and second layer 33. Light emitted by the LED chip 210 passes through the dual index element 220 and is focused by the element 220 to create a desired near-field or far-field optical pattern. The dual index element 220 includes, for example, a core element 230 (e.g., layer 36) having a first index of refraction and a second element 240 (e.g., second layer 33) having a second index of refraction that is different from the first index of refraction. The core element 230 and second element 240 of the element 220 define an interface therebetween at which light may be reflected and/or refracted to provide a desired optical emission pattern and/or to increase light extraction from the package 200. The second element 240 can have a generally toroidal shape, and can be positioned above the substrate 202 around an axis above the LED chip 210. In general, a toroidal surface is a surface generated by a plane closed curve rotated about a line that lies in the same plane as the curve but does not intersect it. Other arrangements, such as layers, of the core element 230 and second element 240 can be used.

Portions of the package body 205 may extend through the substrate 202. In some embodiments, the substrate 202 includes a metal leadframe, and the package body 205 may be formed on the leadframe, for example, by injection molding. In other embodiments, the substrate 202 may include a printed circuit board such as an alumina-based printed circuit board.

A core element 230 can be positioned above the die mounting region 206 in the central space defined by the exemplary toroidal second element 240 as shown. The core element 230 may be formed, for example, as described herein of a nanocomposite comprising a high volume nanoparticle dispersed in a polymer material and may have an index of refraction that is different than the first index of refraction of the second element 240. In some embodiments, the core element 230 nanocomposite may have an index of refraction of about 1.7 to about 2.3. In particular embodiments, the core element 230 nanocomposite may have an index of refraction of about 1.75 or greater.

The core element 230 may include an outer surface 230b and a mating surface 230a. The shape of the mating surface 230a is formed to match the shape of the corresponding mating surface 240a of the second element 240. The shape of the mating surfaces 230a, 240a may be chosen to provide a desired optical pattern of light emitted by the package 200. In the embodiments illustrated in FIG. 2, the mating surface 230a of the core element 230 has a generally convex shape, while the mating surface 240a of the second element 240 has a generally concave shape that is the inverse or reciprocal of the shape of the mating surface 230a of the core element 230. In other aspects, angled arrangements of the elements 230, 240 and/or their surfaces 230a, 240a, can be used.

The elements 230, 240 may or may not include a wavelength conversion material such as a phosphor or include other materials, such as dispersers and/or diffusers. In some embodiments, the LED chip 210 may be coated with a phosphor for wavelength conversion.

The outer surface 230b of the core element 230 is shaped to provide a desired optical pattern, and in some cases may be substantially dome-shaped, as shown in FIG. 8A. Other shapes are possible, depending on the desired optical emission pattern of the package 200. In some embodiments, the second element 240 and the core element 230 may be affixed and/or formed together to form element 220 prior to mounting the element 220 onto the substrate 202.

When a light ray, such as light ray R1 strikes the interface between the core element 230 and the second element 240 (i.e. where the mating surface 230a of the core element 230 and the mating surface 240a of the second element 240 are in contact), a portion of the light ray R1′ may be refracted at the interface, while another portion of the incident light ray R1″ may be reflected due to total internal reflection and the interface. As is known in the art, the difference of index of refraction between the second element 240 and the core element 230 may cause total internal reflection of light rays passing through the higher-index material (in this case, the core element 230) that strike the interface at an angle greater than the critical angle defined by arcsin(n1/n2), where n1 and n2 represent the indices of refraction of the second element 240 and the core element 230, respectively, and n2>n1. However, even when a light ray is totally internally reflected at the interface, some portion of the ray may pass through the interface and be refracted and may form part of the useful light emission of the package 200, thereby increasing the efficiency of the package. Similarly, even if a light ray strikes the interface at an angle that is less than the critical angle, some portion of the light ray may be reflected at the interface.

### EXAMPLES

Using an exemplary methyl-based silicone matrix comprising methylsilicone functionality of a single chain between 300-2500 g/mol was investigated with organosilane moieties. It was observed that additional functionality of various types, including hydride and vinyl groups, can be added and/or substituted with limited effects, if any, on compatibility with the matrix.

For a methylphenyl-based silicone, it was observed that ligands of the organosilane moiety should have the same ratio of methyl-to-phenyl groups as the host silicone of a single chain having a molecular weight between 300-2500 g/mol. Additional functionality of various types, including hydride and vinyl groups, can be added with limited effects on compatibility with the matrix.

It was observed that methylphenyl-based silicones should ideally match the Ph:Me stereochemistry of the host silicone, whether it be block, alternating, random, among others, however would not be a requirement for dispersion of the organosilane moiety or nanoparticle dispersion. In order to determine if a certain molecular structure of a ligand would help compatibilize the nanoparticles into a given silicone matrix, a proxy organosilicone moiety with a given set of chemical properties (backbone chemistry, molecular weight, reactive functionality, etc.) was combined with representative silicone matrices. This screening method allowed quick determination of potential ligands for the organosilane moiety suitable for combining and/or reaction with particular nanoparticles surfaces in dispersion for formulating the presently disclosed silicone nanocomposites and/or their precursor compositions.

Experiments were performed to test the feasibility of selected ligands of the organosilane moiety and their compatibility with base silicone matrices of two different Me:Ph ratios. An acceptable concentration range of organosilane moiety to nanoparticles is about 1.0-40.0 vol % (which is approximately 0.2 to about 11.0 weight percent (wt %)), or a range of about 10.0 volume percent to about 30 vol % (which is about 2.0 weight percent to about 8.0 wt %). As summarized in Table 1, organosilane moieties with methylphenyl ligands were blended with methylphenyl silicones #1 and #2, and methyl-based ligands were mixed with Methylsilicone #1. Molded specimens (1 mm thickness) of silicone-ligand blends were prepared and the percent transmission (% T) was measured at 450 nm using a UV-Vis spectrometer. Incompatible ligands would noticeably reduce the % T value, in part because of scattering due to the formation of agglomerates in the silicone matrix. “Clear” and “Opaque” specimens were defined based on visual observations and not % T data.

### Experiment #1

The data From Table 1 would suggest that the majority of the H- and Vinyl-functional and non-functional methylphenyl ligands of average molecular weights between 485-2750 g/mol, at the concentrations evaluated, maintained compatibility with methylphenyl #1. The Vi-functional (vinyl-Si), linear methyl ligand showed a significantly lower % T as compared to the base silicone matrix even at 2.5 weight percent and opacity at 5.0 wt %. The data for a high molecular weight organosilane moiety (2750 g/mol) was also included in Table 1, illustrating that at lower concentrations, compatibility could be achieved for ligands with low Ph:Me ratios, suggesting that concentration and ligand molecular weight are strongly related. Clarity was lost when the concentration of said high molecular weight ligand was increased to 3.5 wt %, however.

TABLE 1
% Transmission at 450 nm of 1-mm molded Methylphenyl #1 silicone (Ph:Me ratio =
0.81) samples prepared from organosilane moieties with various ligand chemistries. H-
functional = H-Si; Vi-functional = vinyl-Si; and non-functional ligand = alkyl or phenyl.

| Organosilane Moiety | | | | | | |
|---|---|---|---|---|---|---|
| | | Ph:Me | | MW | Ligand | |
| Ligand Type | Trade Name | Ratio | RI | (g/mol) | Wt % | % T (450 nm) |
| None | — | — | — | — | — | 86.44 ± 1.64 |
| H-functional, linear | HPM-502 | 0.20 | 1.500 | 650 | 5.0 | 87.43 ± 1.46 |
| methylphenyl | | | | | 10.0 | 85.80 ± 0.78 |
| Vi-functional, linear | PVV-3522 | 0.43 | 1.530 | 1150 | 5.0 | 88.06 ± 0.68 |
| methylphenyl #1 | | | | | 10.0 | 87.08 ± 1.56 |
| Vi-functional, linear | VPT-1323 | 0.12 | 1.467 | 2750 | 1.75 | 86.97 ± 0.87 |
| methylphenyl #2 | | | | | 3.5 | Opaque |
| Vi-functional, linear | PMV-9925 | 1.00 | 1.537 | 2500 | 7.5 | 85.03 ± 1.32 |
| methylphenyl #3 | | | | | 14.5 | Clear |
| Vi-functional, linear methyl | DMS-V05 | 0.00 | 1.399 | 800 | 2.5 | 70.36 ± 1.10 |
| #2 | | | | | 5.0 | Opaque |
| Non-functional, linear | PDM-7040 | 1.00 | 1.556 | 485 | 5.0 | 86.60 ± 1.17 |
| methylphenyl #1 | | | | | 10.0 | 86.86 ± 0.84 |
| Non-functional, linear | PMM-0021 | 0.25 | 1.520 | 950 | 5.0 | 85.09 ± 0.39 |
| methylphenyl #2 | | | | | 10.0 | 85.60 ± 0.94 |

### Experiment #2

The feasibility of selected ligands and their compatibilities with Methylphenyl silicone #2 was also determined. As for Methylphenyl #1 most of the H- and Vi-functional and non-functional methylphenyl ligands of average molecular weights between 485-1150 g/mol at the concentrations evaluated maintained compatibility with Methylphenyl silicone #2. The H-functional, linear methyl ligand reduced the % T for methylphenylsilicone #2 at almost 5.0 wt % and led to an opaque observation at 12.0 wt %.

TABLE 2
% Transmission at 450 nm of 1-mm molded Methylphenyl #2 silicone
(Ph:Me ratio = 0.31) samples with organosilane moieties with various ligand chemistries.

| Organosilane Moiety | | | | | | |
|---|---|---|---|---|---|---|
| | Trade | Ph:Me | | MW | Ligand | % T |
| Ligand Type | Name | Ratio | RI | (g/mol) | Wt % | (450 nm) |
| None | — | — | — | — | — | 85.32 ± 1.32 |
| H-functional, linear methylphenyl | HPM-502 | 0.20 | 1.500 | 650 | 5.0 | 89.64 ± 0.70 |
| | | | | | 10.0 | 89.64 ± 1.68 |
| Vi-functional, linear methylphenyl | PVV-3522 | 0.43 | 1.530 | 1150 | 5.0 | 88.59 ± 1.80 |
| #1 | | | | | 10.0 | 88.48 ± 1.01 |
| H-functional, linear methyl #2 | DMS-H11 | 0.00 | 1.399 | 1050 | 4.7 | 82.66 ± 2.20 |
| | | | | | 12.0 | Opaque |
| Non-functional, linear | PDM-7040 | 1.00 | 1.556 | 485 | 5.0 | 88.89 ± 0.70 |
| methylphenyl #1 | | | | | 10.0 | 89.30 ± 0.56 |
| Non-functional, linear | PMM-0021 | 0.25 | 1.520 | 950 | 5.0 | 89.63 ± 0.47 |
| methylphenyl #2 | | | | | 10.0 | 89.60 ± 0.52 |

### Experiment #3

The compatibility of various ligands with a methyl-based silicone matrix were tested by observing the clarity of the resultant combination of silicone matrix with dispersed nanoparticles. As seen in Table 2, all samples tested with a Ph:Me ratio of 0.0 resulted in “clear” formulations and coatings with no signs of cloudiness or opacity. However, when attempting to mix a methylphenyl ligand (5.0 wt %) with a fairly high Ph:Me ratio into the methysiloxane, clarity was lost and an opaque sample resulted, which may or may not effect luminous output as discussed later.

TABLE 3
% Transmission at 450 nm of 1-mm molded Methyl silicone #1 (Ph:Me ratio = 0.00)
samples with organosilane moieties with various ligand chemistries.

| Organosilane Moiety | | | | | | |
|---|---|---|---|---|---|---|
| | Trade | Ph:Me | | MW | Ligand | Clarity |
| Ligand Type | Name | Ratio | RI | (g/mol) | Wt % | Observation |
| None | — | — | — | — | — | Clear |
| Vi-functional, linear | DMS-V03 | 0.00 | 1.395 | 500 | 5.0 | Clear |
| methyl #1 | | | | | 10.0 | Clear |
| Vi-functional, linear | DMS-V05 | 0.00 | 1.399 | 800 | 5.0 | Clear |
| methyl #2 | | | | | 10.0 | Clear |
| H-functional, linear | DMS-H03 | 0.00 | 1.395 | 400 | 5.0 | Clear |
| methyl #1 | | | | | 10.0 | Clear |
| H-functional, linear | DMS-H11 | 0.00 | 1.399 | 1050 | 5.0 | Clear |
| methyl #2 | | | | | 10.0 | Clear |
| Vi-functional, linear | PVV-3522 | 0.43 | 1.530 | 1150 | 5.0 | Opaque |
| methylphenyl #1 | | | | | | |
| Non-functional, linear | DMS-T02 | 0.00 | 1.390 | 410 | 5.0 | Clear |
| methyl #1 | | | | | 10.0 | Clear |
| Non-functional, linear | DMS T07 | 0.00 | 1.398 | 950 | 5.0 | Clear |
| methyl #2 | | | | | 10.0 | Clear |

Thus, the above compositions and methods provide for high refractive index coatings/lenses/phosphor binder for greater light extraction from LED chips/phosphor particles or any optical material with a high (>1.7) refractive index.

The above compositions and methods also provide for incorporation of nanoparticles, alone or in combination with microparticles, that increase the high temperature durability of silicone coatings/lenses/phosphor binders, and also contribute to increased room-temperature strength or elastic modulus. Combinations of nano- and micro particles also improve optical properties such as wavelength conversion efficiency or filtering efficiency of the composite. The above compositions and methods also provide for incorporation of nanoparticles into silicone coatings/lenses/phosphor binders that down-convert blue light to one or more wavelengths or wavelength ranges (e.g., green, yellow, red).

The above compositions and methods also for incorporation of nanoparticles that modify the optical absorption of silicone composites: e.g., spectral filtering (e.g., addition of neodymium compounds such as, but not limited to neodymium oxide to achieve spectral “notching”), light diffusion, or other optical functionality.

Any aspect or features of any of the embodiments described herein can be used with any feature or aspect of any other embodiments described herein or integrated together or implemented separately in single or multiple components. It should be understood that features from any of the various embodiments or described herein can be combined together to form other embodiments as would be understood by one of ordinary skill in the art with the benefit of this present description.

It cannot be overemphasized that with respect to the features described above with various example embodiments of a LED lamp, the features can be combined in various ways. For example, the various methods of including phosphor in the lamp can be combined and any of those methods can be combined with the use of various types of LED arrangements such as bare die vs. encapsulated or packaged LED devices. The embodiments shown herein are examples only, shown and described to be illustrative of various design options for a lamp with an LED array.

Although specific embodiments have been illustrated and described herein, those of ordinary skill in the art appreciate that any arrangement, which is calculated to achieve the same purpose, may be substituted for the specific embodiments shown and that the present disclosure has other applications in other environments. This application is intended to cover any adaptations or variations of the present disclosure. The following claims are in no way intended to limit the scope of the present disclosure to the specific embodiments described herein.

1. A nanocomposite composition comprising:
one or more nanoparticles associated with one or more coupling agents; and
a polymer matrix dispersed in the one or more nanoparticles.

2. The nanocomposite composition of claim 1, wherein the one or more nanoparticles are present at more than about 10 volume percent to less than 99 volume percent.

3. The nanocomposite composition of claim 1, wherein the one or more nanoparticles are present at about 50 weight percent to less than 99 weight percent.

4. The nanocomposite composition of claim 1, wherein the polymer matrix is a polysiloxane polymer, or one or more precursor components, blends, or copolymers thereof.

5. The nanocomposite composition of claim 1, wherein the one or more coupling agents comprise one or more chemical functional groups and/or one or more ligands providing compatibility with the polymer matrix.

6. The nanocomposite composition of claim 5, wherein the polymer matrix comprises one or more functional groups capable of reacting with the one or more chemical functional groups of the one or more coupling agents.

7. The nanocomposite composition of claim 5, wherein the one or more nanoparticles are coupled to the one or more coupling agents and/or the polymer matrix.

8. The nanocomposite composition of claim 1, wherein the composition is a curable coating, film, layer, or shape.

9. The nanocomposite composition of claim 1, wherein the one or more nanoparticles are of an average refractive index of between 1.7 and 2.9.

10. The nanocomposite composition of claim 1, wherein the one or more nanoparticles are diamond, silicon carbide, calcium titanate, oxides of one or more of zirconium, hafnium, yttrium, titanium, tin, zinc, antimony or mixtures thereof.

11. The nanocomposite composition of claim 1, wherein the nanocomposite has a refractive index of 1.55 to about 1.80.

12. The nanocomposite composition of claim 1, wherein the nanocomposite comprises a polyalkylsiloxane, polyphenylsiloxane, polyalkyl-phenylsiloxane, epoxy resin, glass, sol-gel, aerogel, or an optically stable polymer and the one or more nanoparticles comprise diamond, silicon carbide, calcium titanate, oxides of one or more of zirconium, hafnium, yttrium, titanium, tin, zinc, antimony or mixtures thereof.

13. The nanocomposite composition of claim 1, wherein the polymer matrix is a two-part curable resin.

14. The nanocomposite composition of claim 1, further comprising nanoparticles and/or microparticles of light-diffusing agents, spectral notch filters, or wavelength shifting agents.

15. A method of dispersing nanoparticles in a polymer matrix, the method comprising:
contacting one or more nanoparticles or their corresponding precursor materials dispersed in a liquid medium with:
(i) one or more coupling agents, the coupling agents having one or more chemical functional groups and one or more ligands; and/or
(ii) a polymer matrix; and
dispersing the polymer matrix in the one or more nanoparticles, the nanoparticles present in an amount greater than 10 volume percent.

16. The method of claim 15, wherein the one or more coupling agents are contacted with the one or more nanoparticles prior to contacting with the polymer matrix.

17. The method of claim 15, wherein the one or more coupling agents are contacted with the polymer matrix prior to contacting with the one or more nanoparticles.

18. The method of claim 15, wherein the one or more chemical functional groups chemically react with the one or more nanoparticles and/or the polymer matrix.

19. The method of claim 15, wherein the polymer matrix comprises one or more precursor components capable of curing, the method further comprising curing the polymer matrix and forming a coating, film, layer, or shape.

20. The method of claim 15, wherein the dispersed one or more nanoparticles are present in the polymer matrix in an amount greater than 50 weight percent.

21. The method of claim 15, wherein the one or more nanoparticles comprise diamond, silicon carbide, calcium titanate, oxides of one or more of zirconium, hafnium, yttrium, titanium, tin, zinc, antimony or mixtures thereof.

22. The method of claim 15, wherein the coupling agent comprises silicon, germanium, or tin.

23. The method of claim 15, wherein the functional groups are one or more of carboxyl, hydroxyl, amino, or thiol.

24. The method of claim 15, wherein the ligands are one or more of vinyl, acryl, methacryl, or hydride.

25. The method of claim 15, wherein the polymer matrix is a polyalkylsiloxane, polyphenylsiloxane, or polyalkyl-phenylsiloxane.

26. A light-emitting device comprising:
at least one LED configured to emit light responsive to a voltage applied thereto;
a nanocomposite at least partially encapsulating the at least one LED, the nanocomposite comprising a first polymer matrix dispersed in at least 10 volume percent of one or more first nanoparticles.

27. The light-emitting device of claim 26, wherein the one or more first nanoparticles are present at more than about 10 volume percent to less than 99 volume percent.

28. The light-emitting device of claim 26, wherein the one or more first nanoparticles are present at about 50 weight percent to less than 99 weight percent.

29. The light-emitting device of claim 26, wherein at least a portion of the one or more first nanoparticles comprise one or more coupling agents, the one or more coupling agents comprising one or more chemical functional groups associated with the one or more first nanoparticles or the first polymer matrix; and one or more ligands providing compatibility with the first polymer matrix.

30. The light-emitting device of claim 26, wherein the first polymer matrix comprises one or more functional groups coupled with the one or more chemical functional groups of the one or more coupling agents.

31. The light-emitting device of claim 26, wherein the one or more first nanoparticles are coupled to the one or more coupling agents and the first polymer matrix.

32. The light-emitting device of claim 26, wherein the one or more first nanoparticles comprise diamond, silicon carbide, calcium titanate, oxides of one or more of zirconium, hafnium, yttrium, titanium, tin, zinc, antimony, or mixtures thereof.

33. The light-emitting device of claim 26, wherein the nanocomposite forms a first layer at least partially encapsulating the at least on LED, and further comprising a second layer at least partially encapsulating or deposited on the first layer, the second layer comprising a second polymer matrix and second particles, the second layer having at least one of a physical, chemical, or functional property different from the first layer.

34. The light-emitting device of claim 33, wherein the one or more first nanoparticles comprise diamond, silicon carbide, calcium titanate, oxides of one or more of zirconium, hafnium, yttrium, titanium, tin, zinc, antimony, or mixtures thereof; and wherein the second particles comprise diamond, silicon carbide, calcium titanate, oxides of one or more of zirconium, hafnium, yttrium, titanium, tin, zinc, antimony, or mixtures thereof.

35. The light-emitting device of claim 33, wherein the first polymer matrix or the second polymer matrix, independently, further comprises one or more scattering particles, fillers, light-diffusing agents, spectral notch filters, or wavelength shifting agents.

36. The light-emitting device of claim 26, wherein the polymer matrix is a polyalkylsiloxane, polyphenylsiloxane or polyalkyl-phenylsiloxane, and the one or more first nanoparticles comprise diamond, silicon carbide, calcium titanate, oxides of one or more of zirconium, hafnium, yttrium, titanium, tin, zinc, antimony, or mixtures thereof.

37. The light-emitting device of claim 26, wherein nanocomposite has a refractive index of 1.55 to about 1.80.

38. The light-emitting device of claim 26, wherein the nanocomposite is configured as a continuous or non-continuous layer, film, coating, or shape.

39. The light-emitting device of claim 26, a wherein the amount of the one or more first nanoparticles present provides a measurable increase in luminous output.
